(19) United States
(12) Patent Application Publication
(10) Pub. No.: US 2025/0344868 A1
(43) Pub. Date: Nov. 13, 2025

(54) VIBRATORY STIMULATION APPARATUS

(71) Applicant: TOYOTA BOSHOKU KABUSHIKI KAISHA, Aichi-ken (JP)

(72) Inventor: Tatsuo KAWAI, Chiryu-shi (JP)

(73) Assignee: TOYOTA BOSHOKU KABUSHIKI KAISHA, Aichi-ken (JP)

(21) Appl. No.: 19/092,448

(22) Filed: Mar. 27, 2025

(30) Foreign Application Priority Data
May 8, 2024 (JP) 2024-075864

(51) Int. Cl. A47C 7/72

(52) U.S. Cl. CPC A47C 7/727

(57) ABSTRACT

A vibratory stimulation apparatus includes a vibration applicator configured to apply vibration to a user's body, and an input portion configured to allow music signals output from a sound source to be input to the input portion. The vibratory stimulation apparatus causes the vibration applicator to operate with a vibration waveform obtained by adding a basic waveform, which is a waveform for promoting an effect of preventing frailty, to a music waveform, which is a waveform based on the music signals input to the input portion.

### CROSS-REFERENCE TO RELATED APPLICATIONS

This application claims the benefit of Japanese Patent Application No. 2024-075864 filed on May 8, 2024 with the Japan Patent Office, and the entire disclosure of Japanese Patent Application No. 2024-075864 is incorporated herein by reference.

### BACKGROUND

The present disclosure relates to a vibratory stimulation apparatus and the like for promoting a user's venous return (also referred to as “milking action”) and neural activity (projection from individual receptors in muscles and tendons to sensory neurons, and motor neurons via interneurons).

For example, a massage apparatus disclosed in Japanese Unexamined Patent Application Publication No. 2000-262578 operates a vibration generator in such a manner that the vibration generator generates vibration with maximum amplitude (hereinafter, simply referred to as “amplitude”) kept at a fixed value.

### SUMMARY

An inventor of the present disclosure has discovered through testing and research that “when a vibration generator is operated continuously with amplitude of vibration applied to a user's body being kept at a fixed value, the user feels significant discomfort”. The present disclosure discloses an example of a vibratory stimulation apparatus in view of this point.

It is desirable that a vibratory stimulation apparatus for promoting an effect of preventing frailty comprises, for example, at least elements below.

That is, the elements are a vibration applicator configured to apply vibration to a user's body, an input portion configured to allow music signals output from a sound source to be input to the input portion, and a controller configured to control an operation of the vibration applicator, the controller being configured to operate the vibration applicator with a vibration waveform (hereinafter, referred to as “output waveform”) obtained by adding a vibration waveform (hereinafter, referred to as “basic waveform”) for promoting an effect of preventing frailty to a vibration waveform (hereinafter, referred to as “music waveform”) based on the music signals input to the input portion.

Accordingly, for example, in a state in which music relating to the music waveform is played, when the vibratory stimulation apparatus is used, the user can receive vibration using the vibration waveform for promoting the effect of preventing frailty, that is, using the basic waveform, while enjoying the music.

In other words, the user receives vibratory stimulation using the basic waveform in a state in which user's consciousness is focused on auditory sensation. Therefore, the user can obtain an effect of increasing the motor nerve activity, that is, a venous return effect or a nerve activity effect without being conscious of the vibratory stimulation using the basic waveform.

Thus, the user can obtain the effect of preventing frailty without being strongly conscious of the effect of preventing physical infirmity or functional decline, that is, training for the effect of preventing frailty.

### BRIEF DESCRIPTION OF THE DRAWINGS

Example embodiments of the present disclosure will be described hereinafter by way of example with reference to the accompanying drawings, in which:

FIG. 1 is a diagram illustrating a seat according to a first embodiment;

FIG. 2 is a block diagram of an electrical system of the seat according to the first embodiment;

FIG. 3 is a diagram illustrating an output waveform of a vibration applicator according to the first embodiment;

FIG. 4A is a diagram illustrating an attachment example of a vibration applicator according to a fourth embodiment;

FIG. 4B is a diagram illustrating the attachment example of the vibration applicator according to the fourth embodiment; and

FIG. 5 is a diagram illustrating a seat according to a fifth embodiment.

### DETAILED DESCRIPTION OF EXEMPLARY EMBODIMENTS

Following embodiments of the invention represent examples of embodiments that fall within the technical scope of the present disclosure. In other words, matters and the like to specify the invention recited in the claims are not limited to any specific configuration, structure, or the like described in the following embodiments.

A member or portion that is described at least with a reference numeral is at least one in number except in a case of being accompanied by restrictive words such as “only one”. A vibratory stimulation apparatus according to the present disclosure comprises at least one of elements, such as a member or portion described at least with a reference numeral, and/or structural portions shown in the drawings.

### First Embodiment

The first embodiment is an example, in which a vibratory stimulation apparatus and a vibratory stimulation method according to the present disclosure are applied to a seat, such as a vehicle seat or an easy chair. The present embodiment is effective in preventing, especially, frailty (mental and physical deterioration due to aging).

### 1. Overview of Seat

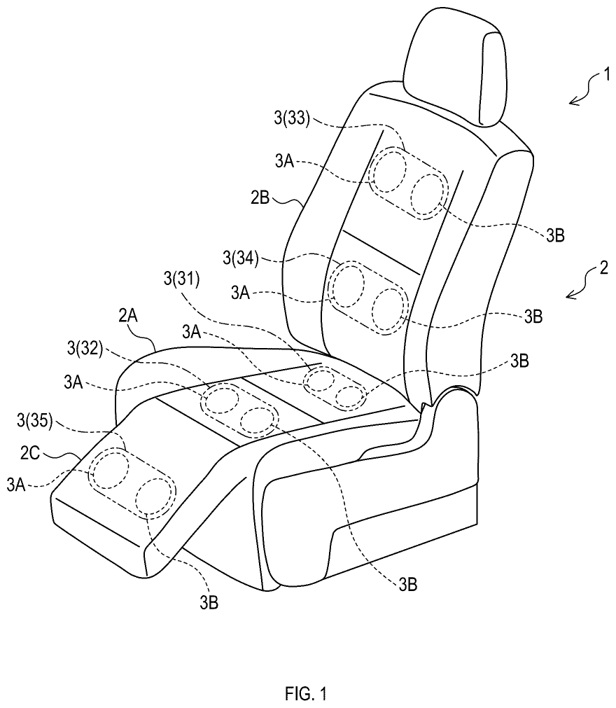

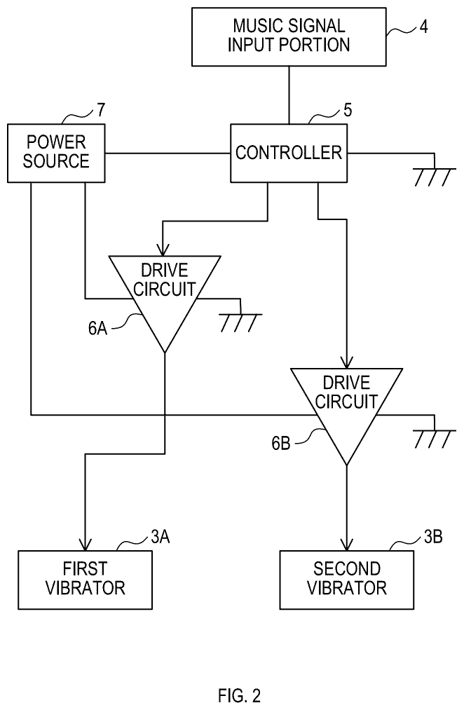

As shown in FIGS. 1 and 2, a seat 1 according to the present embodiment includes, at least, a seat body 2, at least one vibration applicator 3 (in the present embodiment, two or more vibration applicators 3), a music signal input portion 4 (hereinafter, as referred to as “input portion 4”), and a controller 5.

The seat body 2 includes at least one of a seat cushion 2A, a seatback 2B, or an ottoman 2C. The seat cushion 2A supports a lower body, such as legs, of a seated person. The seatback 2B supports an upper body, such as the waist and back, of the seated person. The ottoman 2C supports a lower part of the body below the knees of the seated person, such as the calves.

Each of the vibration applicators 3 applies vibration to the body of the user of the vibratory stimulation apparatus, that is, the user of the seat 1. In the present embodiment, at least one vibration applicator 3 is arranged in each of the seat cushion 2A, the seatback 2B, and the ottoman 2C.

Specifically, vibration applicators 31, 32 are arranged in the seat cushion 2A. Vibration applicators 33, 34 are arranged in the seatback 2B. A vibration applicator 35 is arranged in the ottoman 2C. Hereinafter, all or any of the vibration applicators 31 to 35 are referred to as the “vibration applicators 3”.

Each of the vibration applicators 3 is configured to include a first vibrator 3A and a second vibrator 3B. The first vibrator 3A applies vibration to the right half of the user's body. The second vibrator 3B applies vibration to the left half of the user's body.

Music signals output from a sound source are input to the input portion 4. The sound source is, for example, a portable terminal device such as a smart phone owned by the user or a music reproducing device installed in a vehicle. In addition, a connection between the input portion 4 and the sound source may be wired or wireless.

The controller 5 controls an operation of the vibration applicator 3. The controller 5 can execute frailty prevention vibration mode control (hereinafter, referred to as “frailty prevention control”) using the music signals.

The frailty prevention control according to the present embodiment is control to operate the vibration applicator 3 with a vibration waveform (hereinafter, referred to as “output waveform”) obtained by adding a vibration waveform (hereinafter, referred to as “basic waveform”) for promoting the effect of preventing frailty to a vibration waveform (hereinafter, referred to as “music waveform”) based on the music signals input to the input portion 4.

It is to be noted that the present embodiment employs, as the basic waveform, a waveform having frequency of 20 Hz or higher and 120 Hz or lower and also having a minimum value of amplitude equal to or higher than 0.1 mm (the difference between the minimum value of the amplitude and a maximum value of the amplitude is 0.1 mm or higher).

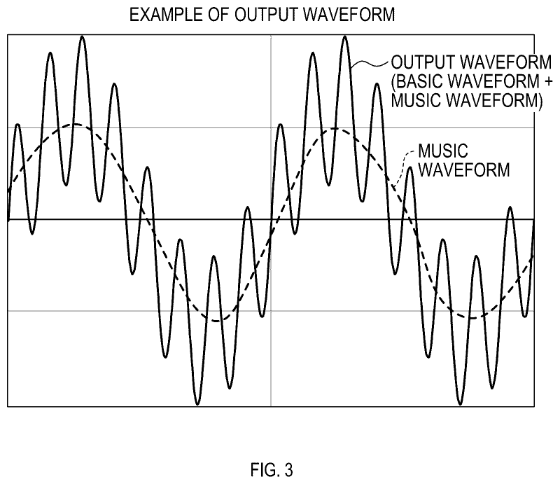

Specifically, the basic waveform according to the present embodiment is a sinusoidal waveform of 80 Hz having the minimum value of the amplitude equal to or higher than 0.1 mm. FIG. 3 shows an example of the output waveform. As shown in FIG. 3, the output waveform is a composite waveform obtained by adding the basic waveform to the music waveform. It is to be noted that FIG. 3 is a diagram showing an illustration of the output waveform and does not show an exact composite waveform.

In FIG. 2, a first drive circuit 6A drives each of the first vibrators 3A in response to receiving a command from the controller 5. A second drive circuit 6B drives each of the second vibrators 3B in response to receiving a command from the controller 5. A power source 7 supplies an electric power to the controller 5, the first drive circuit 6A, the second drive circuit 6B, and the like.

The music signals output from the sound source are adjusted in amplification sensitivity according to user's preferences. Thus, the controller 5 adds the basic waveform according to the amplification sensitivity.

If the output waveform added with the basic waveform exceeds a dynamic range of the music signals, the controller 5 executes a process of keeping the dynamic range of the output waveform within the dynamic range of the music signals, and outputs the signals after this process to the vibration applicators 3.

### 2. Features of Seat (Vibratory Stimulation Apparatus and Vibratory Stimulation Method) According to Present Embodiment

In a state in which music relating to the music waveform is played on the smart phone or the music reproducing device on the vehicle, when the seat (vibratory stimulation apparatus and vibratory stimulation method) according to the present embodiment is used, the user can receive vibration using the vibration waveform for promoting the effect of preventing frailty, that is, using the basic waveform, while enjoying the music.

In other words, the user receives vibratory stimulation using the basic waveform in a state in which user's consciousness is focused on the auditory sensation. Therefore, the user can obtain an effect of increasing an activity of the motor nerve, that is, a venous return effect or a nerve activity effect without being conscious of the vibratory stimulation using the basic waveform.

Thus, the user can obtain the effect of preventing frailty without being strongly conscious of the effect of preventing physical infirmity or functional decline, that is, training for the effect of preventing frailty.

### Second Embodiment

In the first embodiment, the waveform similar to the music signals input to the input portion 4 is used as the music waveform. In the second embodiment, a process (hereinafter, referred to as “filtering process”) is executed in which signals with preset frequency or lower, of the music signals input to the input portion 4, are employed as the music waveform, and then a waveform obtained by adding the basic waveform to the music waveform after the filtering process is employed as the output waveform.

Herein, the above-described “preset frequency” is frequency of the basic waveform. For example, in a case in which the frequency of the basic waveform is 80 Hz, signals exceeding 80 Hz are removed from the music signals so that the music waveform is a waveform containing only signals with 80 Hz or lower.

### Third Embodiment

The aforementioned embodiments have a configuration in which the waveform obtained by adding the basic waveform to the music waveform is the output waveform. The third embodiment has a configuration in which a waveform obtained by multiplying the music waveform by the basic waveform is employed as the output waveform.

It is to be noted that, in a case in which the music waveform is multiplied by the basic waveform, minimum amplitude of the resultant waveform may be smaller than the minimum amplitude of the basic waveform. Thus, in the present embodiment, a process of adjusting amplitude of the output waveform to be equal to or higher than average amplitude of the basic waveform is executed.

This can inhibit significant reduction of the effect of preventing frailty. If the minimum amplitude is smaller than the minimum amplitude of the basic waveform, the effect of preventing frailty may be greatly reduced.

Also in the present embodiment, the music signals applied with the filtering process are used as the music waveform. Alternatively, the music signals not applied with the filtering process may be used as the music waveform.

### Fourth Embodiment

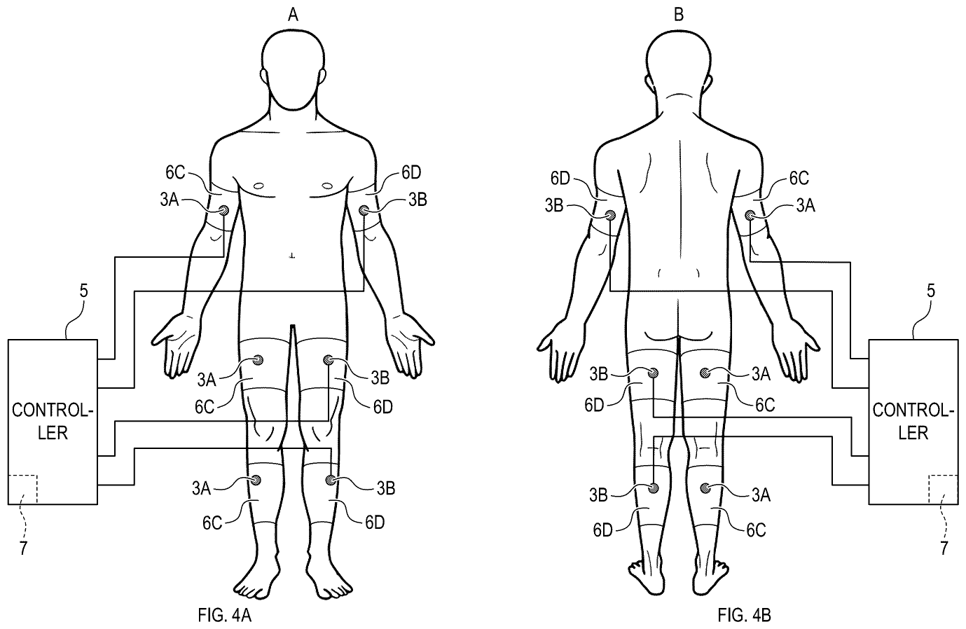

The aforementioned embodiments are examples in which the vibratory stimulation apparatus and the vibratory stimulation method according to the present disclosure are applied to the seat. In contrast, as shown in FIG. 4A and FIG. 4B, the fourth embodiment relates to a vibratory stimulation apparatus comprising a first fastener 6C for fixing the first vibrator 3A to the user's body in close contact, and a second fastener 6D for fixing the second vibrator 3B to the user's body in close contact.

The first fastener 6C and the second fastener 6D according to the fourth embodiment are fasteners, such as a hook and loop fastener, that are easily attachable and detachable. Attachment positions of the first vibrators 3A and the second vibrators 3B shown in FIG. 4A and FIG. 4B are example positions.

The muscle to be vibrated may be any part of the body, such as a muscle belly or a tendon area. In other words, even in any part of the body, it is possible to effectively promote a venous return and a neural activity.

The description above is an explanation of differences from the aforementioned embodiments. The elements and the like that are the same as those in the aforementioned embodiments are denoted by the same reference numerals in the aforementioned embodiments. Thus, in the present embodiment, repetitive description is omitted.

### Fifth Embodiment

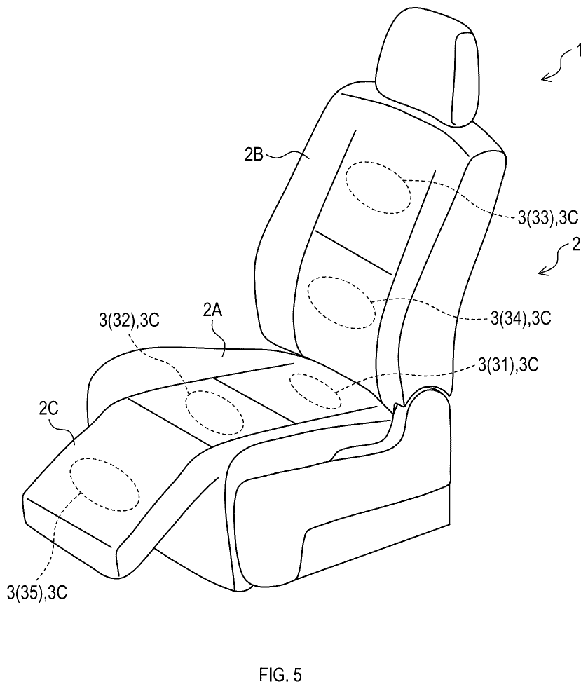

Each of the vibration applicators 3 according to the aforementioned embodiments comprises the first vibrator 3A for the right half body and the second vibrator 3B for the left half body. In contrast, as shown in FIG. 5, each of the vibration applicators 3 according to the fifth embodiment is composed of a single vibrator 3C.

The description above is an explanation of differences from the seat 1 according to the first embodiment. The elements and the like that are the same as those in the aforementioned embodiment are denoted by the same reference numerals in the aforementioned embodiment. Thus, in the present embodiment, repetitive description is omitted.

### Other Embodiments

The basic waveform according to the aforementioned embodiments has 20 Hz or higher and 120 Hz or lower and has the minimum value of the amplitude equal to or higher than 0.1 mm, and the difference between the minimum value of the amplitude and the maximum value of the amplitude is 0.1 mm or higher. However, the present disclosure is not limited thereto.

In the aforementioned embodiments, the respective vibration applicators 3 are configured to vibrate in the same phase. However, the present disclosure is not limited thereto. That is, in the present disclosure, for example, the respective vibration applicators 3 may be configured to vibrate in different phases.

In the aforementioned embodiments, at least one vibration applicator 3 is arranged in each of the seat cushion 2A, the seatback 2B, and the ottoman 2C. However, the present disclosure is not limited thereto. That is, the present disclosure may have a configuration in which, for example, the vibration applicator 3 is arranged solely in the seat cushion 2A, the seatback 2B, or the ottoman 2C.

In the aforementioned embodiments, when the vibratory stimulation apparatus is used, the music waveform is generated using the music signals input to the input portion 4 from the sound source located externally from the vibratory stimulation apparatus. However, the present disclosure is not limited thereto.

That is, the present disclosure may be a vibratory stimulation apparatus including, for example, a storage device that stores a sound source, or a storage that stores a generated music waveform or an output waveform, and the music signals, the music waveform, or the output waveform stored in the storage may be used in next use.

Moreover, it is sufficient that the present disclosure is consistent with the gist of the disclosure described in the above-described embodiments, and the present disclosure is not limited to the above-described embodiments. Therefore, a configuration may be employed in which at least two embodiments among the above-described embodiments are combined together or in which any of the elements shown in the drawings or of the elements described with reference numerals is removed in the above-described embodiments.

What is claimed is:

1. A vibratory stimulation apparatus for promoting an effect of preventing frailty, the vibratory stimulation apparatus comprising:
a vibration applicator configured to apply vibration to a user's body;
an input portion configured to allow music signals output from a sound source to be input to the input portion; and
a controller configured to control an operation of the vibration applicator, the controller being configured to operate the vibration applicator with an output waveform, the output waveform being a vibration waveform obtained by adding a basic waveform to a music waveform, the basic waveform being a vibration waveform for promoting the effect of preventing frailty, the music waveform being a vibration waveform based on the music signals input to the input portion.

2. The vibratory stimulation apparatus according to claim 1, wherein
the controller is capable of executing a process of keeping a dynamic range of the output waveform within a dynamic range of the music signals.

3. The vibratory stimulation apparatus according to claim 2, wherein
the controller is capable of executing a process of employing signals of the music signals, which are input to the input portion, with preset frequency or lower as the music waveform.

4. The vibratory stimulation apparatus according to claim 1, wherein
the basic waveform is a waveform having frequency of 20 Hz or higher and 120 Hz or lower and having a minimum value of amplitude equal to or higher than 0.1 mm.

5. A vibratory stimulation apparatus for promoting an effect of preventing frailty, the vibratory stimulation apparatus comprising:
a vibration applicator configured to apply vibration to a user's body;
an input portion configured to allow music signals output from a sound source to be input to the input portion; and
a controller configured to control an operation of the vibration applicator, the controller being configured to generate an output waveform based on a waveform obtained by multiplying a music waveform by a basic waveform, the output waveform being a vibration waveform used to operate the vibration applicator, the music waveform being a vibration waveform based on the music signals input to the input portion, the basic waveform being a vibration waveform for promoting the effect of preventing frailty.

6. The vibratory stimulation apparatus according to claim 5, wherein
the controller is capable of executing a process of adjusting amplitude of the output waveform to amplitude equal to or higher than average amplitude of the basic waveform.

7. The vibratory stimulation apparatus according to claim 6, wherein
the controller is capable of executing a process of employing signals of the music signals, which are input to the input portion, with preset frequency or lower as the music waveform.

8. The vibratory stimulation apparatus according to claim 5, wherein
the basic waveform is a waveform having frequency of 20 Hz or higher and 120 Hz or lower and having a minimum value of amplitude equal to or higher than 0.1 mm.
